(19) United States
(12) Patent Application Publication
(10) Pub. No.: US 2014/0270477 A1
(43) Pub. Date: Sep. 18, 2014

(54) SYSTEMS AND METHODS FOR DISPLAYING A THREE-DIMENSIONAL MODEL FROM A PHOTOGRAMMETRIC SCAN

(71) Applicant: Jonathan Coon, Austin, TX (US)

(72) Inventor: Jonathan Coon, Austin, TX (US)

(21) Appl. No.: 13/831,198

(22) Filed: Mar. 14, 2013

(51) Int. Cl. G06T 17/00

(52) U.S. Cl. CPC G06T 17/00
USPC 382/154

(57) ABSTRACT

A computer-implemented method for displaying a three-dimensional (3D) model from a photogrammetric scan. An image of an object and a scan marker may be obtained at a first location. A relationship between the image of the object and the image of the scan marker at the first location may be determined. A geometric property of the object may be determined based on the relationship between the image of the object and the image of the scan marker. A 3D model of the object may be generated based on the determined geometric property of the object. The 3D model of the object may be displayed to scale in an augmented reality environment at a second location based on a scan marker at the second location.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. For example, computers have opened up an entire industry of internet shopping. In many ways, online shopping has changed the way consumers purchase products. However, in some cases, consumers may avoid shopping online. For example, it may be difficult for a consumer to know how a product will look in and/or with a certain location such as an office space or a family room in a home. In many cases, this challenge may deter a consumer from purchasing a product online.

### SUMMARY

According to at least one embodiment, a computer-implemented method for displaying a three-dimensional (3D) model from a photogrammetric scan. An image of an object and a scan marker may be obtained at a first location. A relationship between the image of the object and the image of the scan marker at the first location may be determined. A geometric property of the object may be determined based on the relationship between the image of the object and the image of the scan marker. A 3D model of the object may be generated based on the determined geometric property of the object. The 3D model of the object may be displayed to scale in an augmented reality environment at a second location based on a scan marker at the second location.

In one embodiment, the image of the object and the scan marker may be captured at the first location with an image-capturing device. A position of the image-capturing device may be tracked while capturing the image of the object and the scan marker at the first location. The scan marker at the first and second locations may be identified.

In one embodiment, an orientation of the scan marker at the first location may be determined. An orientation of the object based on the determined orientation of the scan marker at the first location may be determined. In one configuration, an orientation of the scan marker at the second location may be determined. An orientation of the 3D model of the object based on the determined orientation of the scan marker at the second location may be determined. In one embodiment, a size of the scan marker at the first location may be determined. A size of the object relative to the determined size of the scan marker at the first location may be determined. A size of the scan marker at the second location may be determined. A size of the 3D model of the object relative to the determined size of the scan marker at the second location may be determined.

In some configurations, the scan marker at the first location may be displayed on a display device. The display device may be positioned adjacent to the object. The 3D model of the object may be displayed over a real-time image of the second location on a display device. A geometric property of the 3D model of the object may be adjusted in relation to an adjustment of a position of the display device. In one embodiment, data may be encoded on the scan marker at the first location. Data may be encoded on the scan marker at the second location. The scan markers may include a quick response (QR) code.

A computer system configured to display a 3D model from a photogrammetric scan is also described. The system may include a processor and memory in electronic communication with the processor. The memory may store instructions that are executable by the processor to obtain an image of an object and a scan marker at a first location, determine a relationship between the image of the object and the image of the scan marker at the first location, and determine a geometric property of the object based on the relationship and the image of the object and the image of the scan marker. The memory may store instructions that are executable by the processor to generate a 3D model of the object based on the determined geometric property of the object and display the 3D model of the object to scale in an augmented reality environment at a second location based on a scan marker at the second location.

A computer-program product displaying a 3D model from a photogrammetric scan. The computer-program product may include a non-transitory computer-readable medium that stores instructions. The instructions may be executable by a processor to obtain an image of an object and a scan marker at a first location, determine a relationship between the image of the object and the image of the scan marker at the first location, and determine a geometric property of the object based on the relationship between the image of the object and the image of the scan marker. The instructions may be executable by a processor to generate a 3D model of the object based on the determined geometric property of the object and display the 3D model of the object to scale in an augmented reality environment at a second location based on a scan marker at the second location.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of a photogrammetry module;

FIG. 4 is a block diagram illustrating one example of an image analysis module;

FIG. 5 is a diagram illustrating another embodiment of an environment in which the present systems and methods may be implemented;

FIG. 6 is a diagram illustrating another embodiment of an environment in which the present systems and methods may be implemented;

FIG. 7 is a diagram illustrating one embodiment of a method to generate a photogrammetric scan of an object;

FIG. 8 is a diagram illustrating one embodiment of a method to determine a geometric property of a photogrammetric scan of an object;

FIG. 9 is a flow diagram illustrating one embodiment of a method to display a photogrammetric scan of an object in an augmented reality environment;

FIG. 10 depicts a block diagram of a computer system suitable for implementing the present systems and methods;

FIG. 11 depicts a block diagram of another computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

In various situations, it may be desirable to display a three-dimensional (3D) model of an object from a photogrammetric scan of the object. For example, it may be desirable to display a 3D model of an object in relation to an augmented reality environment. In some embodiments, the systems and methods described herein may scan an object according to a specific photogrammetric standard. In some cases, an object may be photogrammetrically scanned in relation to a scan marker positioned at a location relative to the object. The scan marker may be printed on a piece of paper. Additionally or alternatively, a scan marker may be displayed on the display of a device. For instance, the systems and methods described herein may allow for proper scaling of a 3D model of an object when virtually placing a 3D model of an object in a real-time image of a certain location (e.g., virtually placing a 3D model of a chair in a real-time image of a family room). Although many of the examples used herein describe the displaying of a 3D model of furniture, it is understood that the systems and methods described herein may be used to display a model of any object.

FIG. 1 is a block diagram illustrating one embodiment of computer system 100 in which the present systems and methods may be implemented. In some embodiments, the systems and methods described herein may be performed on a single device (e.g., device 105). For example, the systems and method described herein may be performed by a photogrammetry module 115 that is located on the device 105. Examples of devices 105 include mobile devices, smart phones, personal computing devices, computers, servers, etc. Although the depicted computer system 100 is shown and described herein with certain components and functionality, other embodiments of the computer system 100 may be implemented with fewer or more components or with less or more functionality. For example, in some embodiments, the photogrammetry module 115 may be located on both devices 105. In some embodiments, the computer system 100 may not include a network, but may include a wired or wireless connection directly between the devices 105. In some embodiments, the computer system 100 may include a server and at least some of the operations of the present systems and methods may occur on a server. Additionally, some embodiments of the computer system 100 may include multiple servers and multiple networks. In some embodiments, the computer system 100 may include similar components arranged in another manner to provide similar functionality, in one or more aspects.

In some configurations, a device 105 may include the photogrammetry module 115, a camera 120, a display 125, and an application 130. In one example, the device 105 may be coupled to a network 110. Examples of networks 110 include local area networks (LAN), wide area networks (WAN), virtual private networks (VPN), cellular networks (using 3G and/or LTE, for example), etc. In some configurations, the network 110 may be the internet. In one embodiment, the photogrammetry module 115 may display a 3D model of an object from a photogrammetric scan of the object. In one example, a 3D model of an object enables a user to view the 3D model of the object in relation to a real-time image of a room on the display 125. For instance, a user may activate the camera 120 to capture a real-time image of a room in which the user is located. The camera 120 may configured as a still-photograph camera such as a digital camera, a video camera, or both. The 3D model of an object may be displayed in relation to the real-time image. For example, the 3D model may include a 3D model of a photogrammetrically scanned chair. The 3D model of the chair may be superimposed over the real-time image to create an augmented reality in which the 3D model of the chair appears to be located in the room in which the user is located. In some embodiments, the 3D model of the object may be immersed into a 3D augmented reality environment.

FIG. 2 is a block diagram illustrating another embodiment of an environment 200 in which the present systems and methods may be implemented. In some embodiments, a device 105 may communicate with a server 210 via a network 110. In some configurations, the devices 105-b-1 and 105-b-2 may be examples of the devices 105 illustrated in FIG. 1. For example, the devices 105-b-1 and 105-b-2 may include the camera 120, the display 125, and the application 130. Additionally, the device 105-b-1 may include the photogrammetry module 115. It is noted that in some embodiments, the device 105-b-1 may not include a photogrammetry module 115.

In some embodiments, the server 210 may include the photogrammetry module 115. In some embodiments, the photogrammetry module 115 may be located solely on the server 210. Alternatively, the photogrammetry module 115 may be located solely on one or more devices 105-b. In some configurations, both the server 210 and a device 105-b may include the photogrammetry module 115, in which case a portion of the operations of the photogrammetry module 115 may occur on the server 210, the device 105-b, or both.

In some configurations, the application 130 may capture one or more images via the camera 120. For example, the application 130 may use the camera 120 to capture an image of an object with a scan marker adjacent to the object (e.g., a chair with a scan marker on the floor next to the chair). In one example, upon capturing the image, the application 130 may transmit the captured image to the server 210. Additionally or alternatively, the application 130 may transmit a 3D model of the object to the server 210. The server 210 may transmit the captured image and/or 3D model of the object to a device 105 such as the depicted device 105-b-2. Additionally or alternatively, the application 130 may transmit the captured image and/or 3D model of the object to the device 105-b-2 through the network 110 or directly.

In some configurations, the photogrammetry module 115 may obtain the image and may generate a scaled 3D model of the object (e.g., a scaled 3D representation of a chair) as describe above and as will be described in further detail below. In one example, the photogrammetry module 115 may transmit scaling information and/or information based on the scaled 3D model of the object to the device 105-b. In some configurations, the application 130 may obtain the scaling information and/or information based on the scaled 3D model of the object and may output an image based on the scaled 3D model of the object to be displayed via the display 125.

FIG. 3 is a block diagram illustrating one example of a photogrammetry module 115-a. The photogrammetry module 115-a may be one example of the photogrammetry module 115 illustrated in FIG. 1 or 2. As depicted, the photogrammetry module 115-a may include an image analysis module 305, a positioning module 310, a 3D generation module 315, an encoding module 320, and an augmented reality module 325.

In some configurations, the photogrammetry module 115-a may obtain an image of an object and a scan marker. In one example, the image may depict only a portion of an object and only a portion of the scan marker. The scan marker may have a known size. For example, the photogrammetry module 115-a may obtain an image of a chair and a scan marker at a first location. The scan marker may be positioned in the same location as the chair, visibly adjacent to the chair (such as on the floor next to or touching the chair), or at other locations relative to the location of the chair. In some embodiments, the photogrammetry module 115-a may display the scan marker at the first location on a display device. For instance, a device 105 may be positioned visibly adjacent to the object being scanned and the scan marker may be displayed on the display 125 of a device 105. Additionally or alternatively, the photogrammetry module 115-a may display a scan marker on the display 125 of a device 105 at a second location. The second location may be a different area of the same room or may be a location in another part of the world. For example, in one embodiment a user may desire to see how an object in one corner of a family room may appear in another corner of the same family room. In another example, a user in the United States may desire to see how an object physically located in a warehouse of another country such as Germany would appear in the user's family room located in the United States.

In some embodiments, the photogrammetry module 115-a may include an image analysis module 305, a positioning module 110, a 3D generation module 315, and an encoding module 320. In one embodiment, the photogrammetry module 115-a may scale the 3D model of the object based on the known size of the scan marker. For example, the photogrammetry module 115-a may directly apply the scale from the image of the scan marker (which has a known size) to the 3D model of the object. For instance, the scale of the scan marker may be directly applied to the 3D model of the object because a 3D model of the object and the scan marker are mapped into a 3D space based on the image. For instance, the photogrammetry module 115-a may define the mapped 3D model of the object as scaled according to the same scaling standard as the scaling standard of the scan marker. The 3D model of the object may be stored as a scaled 3D model of the object (scaled according to the scaling standard of the scan marker, for example).

In one embodiment, the image analysis module 305 may determine a relationship between an image of an object and an image of a scan marker. The object and scan marker may be located at a first location. The image analysis module 305 may capture the image of the object and the scan marker at the first location with an image-capturing device such as a camera 120. The image analysis module 305 may analyze an object in relation to a scan marker depicted in an image. For example, the image analysis module 305 may detect the orientation (e.g., relative orientation) of an object, the size (e.g., relative size) of an object, and/or the position (e.g., the relative position) of an object. Additionally or alternatively, the image analysis module 305 may analyze the relationship between two or more objects in an image. For example, the image analysis module 305 may detect the orientation of a first object (e.g., a chair, the orientation of the chair, for example) relative to a detected orientation of a second object (e.g., a scan marker, the orientation of the visible portion of the scan marker, for example). In another example, the image analysis module 305 may detect the position of an object relative to the detected position of a scan marker. In yet another example, the image analysis module 305 may detect the size of an object relative to the detected size of the scan marker. For instance, in the case that the image depicts a chair with a scan marker positioned visibly adjacent to the chair, the image analysis module 305 may detect the shape, orientation, size, and/or position of the scan marker, and the shape, orientation, size, and/or position of the chair (with respect to the shape, orientation, size, and/or position of the scan marker, for example).

In one embodiment, the positioning module 310 may determine a position of a device 105. For instance, positioning module 310 may be configured to track a position of a device 105 while a camera 120 on the device 105 captures an image of an object and a scan marker at a first location. Additionally or alternatively, the positioning module 310 may be configured to track a position of a device 105 while a camera 120 on the device 105 captures a real-time, live image of a scan marker at a second location. For example, the positioning module 310 may interface a global positioning system (GPS) located on a device 105 to determine a position of the device 105. Additionally or alternatively, the positioning module 310 may interface an accelerometer and/or a digital compass located on a device 105 to determine a position of the device 105. Thus, in addition to the image analysis of a geometric property of an object relative to a scan marker from an image of the object and scan marker, the positioning module 310 may provide positioning information to augment the analysis performed by the image analysis module 305 as well as positioning information to generate an augmented reality at the second location.

Upon determining a geometric property of an object relative to a scan marker from an image of the object and scan marker, in one embodiment, the 3D generation module 315 may generate a 3D model of the object. For instance, the 3D generation module 315 may generate a 3D model of a chair based on a geometric property of the chair determined by the image analysis module 305. The photogrammetry module 115-a may then allow a user to send a 3D model of the object to a device 105 located at a second location.

In one embodiment, the encoding module 320 may be configured to encode data on a scan marker. For instance, the scan marker may include information encoded by the encoding module 320. For example, the scan marker may include a matrix barcode such as a quick response (QR) code, a tag barcode such as a Microsoft® tag barcode, or other similar optical machine-readable representation of data relating to an object to which it is attached or an object near which it is displayed. The scan marker may be printed. The printed scan marker may be placed visibly adjacent to an object that is photogrammetrically scanned by the photogrammetry module 115-a on a device 105. Additionally or alternatively, as described above, the scan marker may be displayed on the display 125 of a device 105 positioned visibly adjacent to the object being scanned. In some configurations, the encoding module 320 may encode identification information such as the identification of the object that is photogrammetrically scanned. The encoded information may include information related to a geometric property of a first location, a scan marker, and/or an object photogrammetrically scanned. Additionally or alternatively, the encoded information may include information related to a second location, a device 105, and/or a 3D model of an object.

In one embodiment, the augmented reality module 325 may display a 3D model of the object to scale in an augmented reality environment. The augmented reality module 325 may display the 3D model of the object in an augmented reality environment at a second location. The augmented reality module 325 may display the 3D model of the object based on a scan marker visibly positioned at the second location. For instance, the augmented reality module 325 may display a 3D model of a chair over a real-time image of the second location on the display 125 of a device 105 that captures the real-time image. For example, the photogrammetry module 115-a may display a 3D model of a chair to scale in a real-time image of a user's family room. The user may hold a device 105 with a camera 120 to capture the live view of the user's family room. In one embodiment, the augmented reality module 325 may display the 3D model of the object over the real-time image of the second location. For example, the photogrammetry module 115-a may superimpose a 3D model of the chair over a real-time image of a second location. Thus, the superimposed 3D model of the chair may provide the user with a view of how the chair would appear in the user's family room without the user having to purchase the chair or physically place the chair in the user's family room. In some embodiments, the 3D model of the object may be immersed into a 3D rendering of an augmented reality environment. In other words, the augmented reality module 325 may determine a geometric property of the second location including, but not limited to, depth, shape, size, orientation, position, etc. Based on the determined geometric property of the second location, the augmented reality module 325 may position the 3D model of the object in an augmented reality 3D space of the second location. In some embodiments, the photogrammetry module 115-a may determine a geometric property (e.g., shape, size, scale, position, orientation, etc.) of the 3D model of the object based on a scan marker positioned at the second location. In some configurations, a device 105 that is displaying on a display 125 a real-time image of the second location via a camera 120 may determine a geometric property of the scan marker at the second location, including shape, size, scale, depth, position, orientation, etc. The determined geometric property of the scan marker at the second location may provide a device 105 data with which to determine a relative geometric property of the 3D model of the object. For example, the scan marker at the second location may provide the device 105 a relative scale with which to scale the 3D model of the object. A device 105 may display the scaled 3D model of the object in a real-time, augmented reality environment of the second location. In some embodiments, the scan marker at the second location may be displayed on a display 125 of a device 105 positioned at the second location.

FIG. 4 is a block diagram illustrating one example of an image analysis module 305-a. The image analysis module 305-a may be one example of the image analysis module 305 illustrated in FIG. 3. In some embodiments, the image analysis module 305-a may include an identification module 405 and a geometric module 410.

In one embodiment, the identification module 405 may identify a scan marker in an image of the scan marker. For example, the image may include at least a portion of an object and a scan marker visibly adjacent to the portion of the object in the image. In one embodiment, the identification module 405 may identify a scan marker at a first location. Additionally or alternatively, the identification module 405 may identify a scan marker at a second location. The scan marker may be printed such as on a piece of paper. Additionally or alternatively, the scan marker may be displayed on a display 125 of a device 105. The identification module 405 may identify at least a portion of the object in the image. In some embodiments, the identification module 405 may identify a device 105 displaying the scan marker on a display 125 of the device 105. In some embodiments, the identification module 405 may identify an optical machine-readable representation of data. For example, as described above, the scan marker may include a matrix or tag barcode such as a QR code. The identification module 405 may identify a barcode displayed adjacent to an object at a first location.

In one embodiment, the geometric module 410 may determine a geometric property of an object based on a relationship between an image of the object and an image of the scan marker. For example, the geometric module 410 may determine a shape, size, scale, position, orientation, depth, or other similar geometric property. In some configurations, the geometric module 410 may be configured to determine an orientation of the scan marker at the first location. The geometric module 410 may determine an orientation of the object based on the determined orientation of the scan marker at the first location. For example, the geometric module 410 may determine a size of the scan marker at the first location. The first location may include a manufacturing site of a chair. In other words, in some embodiments, the object such as a chair is physically located at the first location. Upon determining a size of the scan marker at the first location, the geometric module 410 may determine a size of the object relative to the determined size of the scan marker at the first location. In some embodiments, the geometric module 410 may determine an orientation of the scan marker at the second location. Upon determining an orientation of the scan marker at the second location, the geometric module 410 may determine an orientation of the 3D model of the object. In some embodiments, the geometric module 410 may determine a size of a scan marker at a second location. Upon determining a size of the scan marker at the second location, the geometric module 410 may determine a size of the 3D model of the object relative to the determined size of the scan marker at the second location. In some configurations, the geometric module 410 may adjust a geometric property of the 3D model of the object in relation to a detected adjustment of a position of a device 105. For example, a user may capture a real-time, live view of the user's family room. The augmented reality module 325 may insert the scaled 3D model of the photogrammetrically scanned object in the live view of the user's family room. Hence, the augmented reality 325 may generate an augmented reality view of the user's family room in which the object appears to be positioned in the user's family room via the display 125 of the device 105 capturing the real-time view of the user's family room. A scan marker visibly positioned in the user's family room may provide the photogrammetry module 115-a a reference with which to position the 3D model of the object in the real-time view of the user's family room. As the user adjusts the position of the device 105 capturing the real-time view of the user's family room, the geometric module 410 may adjust a relative geometric property of the 3D model of the object including, but not limited to, the size, orientation, shape, or position of the 3D model of the object.

FIG. 5 is a diagram illustrating another embodiment of an environment 500 in which the present systems and methods may be implemented. The environment 500 includes a first device 105-c-2, an object 505, and a second device 105-c-1. The devices 105 may be examples of the devices shown in FIG. 1 or 2.

As described above, a camera 120 on a device 105-c-2 may capture an image of an object 505 and a scan marker 510. The object 505 and scan marker 510 may be located at a first location. In one embodiment, the scan marker may include an optical machine-readable representation of data. For example, the scan marker may include a matrix barcode such as a QR code or a tag barcode such as a Microsoft® tag barcode. In some embodiments, the scan marker may be displayed on a display 125 of a device 105-c-1. Additionally or alternatively, the scan marker 510 may be printed such as on a piece of paper. As depicted, an application 130 may allow a user to capture an image 515 of an object 505 and a scan marker 510. In some embodiments, a user may capture several images at different angles around the object 505 and scan marker 510. Additionally or alternatively, a user may capture video of the object 505 and scan marker while moving around the object 505 and scan marker 510. The image analysis module 305 may analyze an image of the object 520 in relation to an image of the scan marker 525. The image of the object 520 and the image of the scan marker 525 may be contained in the same image 515. The photogrammetry module 115 may photogrammetrically scan the object 505 in relation to the scan marker 510. The 3D generation module 315 may generate a 3D model of the photogrammetrically scanned object. A user may send the 3D model of the object to a device 105-c-2 located at a second location. The 3D model of the object may be viewed at any time on the device 105 at the second location after its being received.

In one embodiment, the image analysis module 305 may determine a relationship between the image of the object 520 and the image of the scan marker 525. For instance, a user may capture an image of a chair located in a first location. A scan marker may be positioned adjacent to the chair so that the user captures an image of the chair and the scan marker. In some embodiments, the user may capture a video of the chair and the scan marker. For instance, the user may move around the object capturing video of the chair and the scan marker. The image analysis module 305 may analyze an individual image contained in the captured video. In some embodiments, the user may take several photographs of the chair and scan marker at different angles around the chair and scan marker. The image analysis module 305 may analyze an image of the chair and the scan marker to determine a relationship between the chair and scan marker, including, but not limited to, shape, size, scale, position, and orientation. For instance, based on a predetermined size of the scan marker, the image analysis module may compare the known size of the scan marker in the image to determine the relative size of the chair in the image. Thus, the scan marker 510 provides a geometric reference to the object 505 to enable the image analysis module 305 to analyze and determine a geometric property of the object 505. In some embodiments, the image analysis module 305 captures the image of the object 520 and the scan marker 525 at a first location with an image-capturing device such as a camera 120.

FIG. 6 is a diagram illustrating another embodiment of an environment 600 in which the present systems and methods may be implemented. The environment 600 includes a 3D model of an object 610 displayed on a real-time image 605 of a second location. The real-time image 605 includes an image of a scan marker 615. As depicted, the scan marker 620 is displayed on a display 125 of a second device 105-d-2. In some embodiments, as described above, the scan marker may be printed on a piece of paper. Thus, an application 130 on the first device 105-d-1 may allow a user to capture a real-time, live image 605 of a second location. In some embodiments, the geometric module 410 may determine a geometric property of the scan marker 620 at the second location such as size, position, orientation, scale, etc. Based on the determined geometric property of the scan marker 620, the geometric module 410 may determine a relative geometric property of the 3D model of the object 610. Based on the determined relative geometric property of the 3D model of the object 610, the augmented reality module 325 may generate an augmented reality environment of the second location that includes the 3D model of the object 610 virtually positioned in the live image 605 of the second location. Thus, as explained above, the augmented reality environment may provide a user with a view of how an object would appear at the second location without the user having to purchase the object or physically place the object at the second location.

FIG. 7 is a diagram illustrating one embodiment of a method 700 to generate a photogrammetric scan of an object. In some configurations, the method 700 may be implemented by the photogrammetry module 115 illustrated in FIG. 1, 2, or 3. In some embodiments, elements of the method 700 may be implemented by the application 130 illustrated in FIG. 1, 2, 5, or 6.

In one embodiment, the image analysis module 305 may obtain 705 an image of an object and a scan marker at a first location. For example, a camera 120 on a device 105 may capture one or more images of an object 505 and a scan marker 510. The image analysis module 305 may determine 710 a relationship between an object and a scan marker in a captured image. In some configurations, the geometric module 410 may determine 715 a geometric property of the object 505 based on a determined relationship between the image of the object 520 and the image of the scan marker 525. For example, the geometric module 410 may determine a shape, size, position, and/or orientation of the object 505 based on a determined geometric property of the scan marker 510. The 3D generation module 315 may generate 720 a 3D model of the object 610 based on the determined geometric property of the object 505. The augmented reality module 325 may display 725 the 3D model of the object to scale in an augmented reality environment at a second location based on a scan marker 620 at the second location.

FIG. 8 is a diagram illustrating one embodiment of a method 800 to determine a geometric property of a photogrammetric scan of an object. In some configurations, the method 800 may be implemented by the photogrammetry module 115 illustrated in FIG. 1, 2, or 3. In some embodiments, elements of the method 800 may be implemented by the application 130 illustrated in FIG. 1, 2, 5, or 6.

In one embodiment, a camera 120 on a device 105 may capture 805 an image 515 of an object 505 and a scan marker 510 at a first location. In some configurations, the positioning module 310 may track 810 a position on an image-capturing device while capturing an image 515 of the object 505 and the scan marker 510 at the first location. For example, the positioning module 310 may track the position of a device 105 while a camera 120 on the device 105 captures the image 515 of the object 505 and the scan marker 510. The photogrammetry module 115 may display 815 the scan marker 510 at the first location on a display 125 of a device 105 with the device 105 positioned adjacent to the object 505. The identification module 405 may identify 820 the scan marker 510. In some embodiments, the geometric module 410 may determine the orientation of the scan marker 510 at the first location. The geometric module 410 may determine 825 an orientation of the object 505 based on the determined orientation of the scan marker 510 at the first location. In some configurations, the geometric module 410 may determine a size of the scan marker 510 at the first location. The geometric module 410 may determine 830 a size of the object 505 relative to the determined size of the scan marker 510 at the first location. Thus, the photogrammetry module 115 may be configured to determine a geometric property of the object 505 in order to generate a 3D model of the object 505 to scale.

FIG. 9 is a flow diagram illustrating one embodiment of a method 900 to display a photogrammetric scan of an object in an augmented reality environment. In some configurations, the method 900 may be implemented by the photogrammetry module 115 illustrated in FIG. 1, 2, or 3. In some embodiments, elements of the method 900 may be implemented by the application 130 illustrated in FIG. 1, 2, 5, or 6.

In one embodiment, the encoding module 320 may encode 905 data on a scan marker 620. As described above, the scan marker 620 may include an optical machine-readable representation of data such as a matrix barcode. In some configurations, the identification module 405 may identify 910 the scan marker 620 at the second location. In one example, the geometric module 410 may determine 915 an orientation of the scan marker 620 at the second location. Upon determining an orientation of the scan marker 620 at the second location, the geometric module 410 may determine 920 an orientation of the 3D model of the object 610 based on the determined orientation of the scan marker 620. In another example, the geometric module 410 may determine 925 a size of the scan marker 620 at the second location. Upon determining a size of the scan marker 620, the geometric module 410 may determine 930 a relative size of the 3D model of the object based on the determined size of the scan marker 620 at the second location. In some embodiments, the augmented reality module 325 may display 935 the 3D model of the object 610 in a real-time image 605 of the second location.

FIG. 10 depicts a block diagram of a computer system 1000 suitable for implementing the present systems and methods. In one embodiment, the computer system 1000 may include a mobile device 1005. The mobile device 1005 may be an example of a device 105 depicted in FIG. 1, 2, 5, or 6. As depicted, the mobile device 1005 includes a bus 1025 which interconnects major subsystems of mobile device 1005, such as a central processor 1010, a system memory 1015 (typically RAM, but which may also include ROM, flash RAM, or the like), and a transceiver 1020 that includes a transmitter 1030, a receiver 1035, and an antenna 1040.

Bus 1025 allows data communication between central processor 1010 and system memory 1015, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the photogrammetry module 115-b to implement the present systems and methods may be stored within the system memory 1015. The photogrammetry module 115-b may be one example of the photogrammetry module 115 depicted in FIGS. 1, 2, and 3. Applications (e.g., application 130) resident with mobile device 1005 may be stored on and accessed via a non-transitory computer readable medium, such as a hard disk drive, an optical drive, or other storage medium. Additionally, applications can be in the form of electronic signals modulated in accordance with the application and data communication technology when accessed via a network.

FIG. 11 depicts a block diagram of a computer system 1100 suitable for implementing the present systems and methods. The computer system 1100 may be one example of a device 105 depicted in FIG. 1, 2, 5, or 6. Additionally or alternatively, the computer system 1100 may be one example of the server 210 depicted in FIG. 2.

Computer system 1100 includes a bus 1105 which interconnects major subsystems of computer system 1100, such as a central processor 1110, a system memory 1115 (typically RAM, but which may also include ROM, flash RAM, or the like), an input/output controller 1120, an external audio device, such as a speaker system 1125 via an audio output interface 1130, an external device, such as a display screen 1135 via display adapter 1140, a keyboard 1145 (interfaced with a keyboard controller 1150) (or other input device), multiple universal serial bus (USB) devices 1155 (interfaced with a USB controller 1160), and a storage interface 1165. Also included are a mouse 1175 (or other point-and-click device) interfaced through a serial port 1180 and a network interface 1185 (coupled directly to bus 1105).

Bus 1105 allows data communication between central processor 1110 and system memory 1115, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the photogrammetry module 115-c to implement the present systems and methods may be stored within the system memory 1115. The photogrammetry module 115-c may be one example of the photogrammetry module 115 depicted in FIGS. 1, 2, and 3. Applications (e.g., application 130) resident with computer system 1100 are generally stored on and accessed via a non-transitory computer readable medium, such as a hard disk drive (e.g., fixed disk 1170) or other storage medium. Additionally, applications can be in the form of electronic signals modulated in accordance with the application and data communication technology when accessed via interface 1185.

Storage interface 1165, as with the other storage interfaces of computer system 1100, can connect to a standard computer readable medium for storage and/or retrieval of information, such as a fixed disk drive 1144. Fixed disk drive 1144 may be a part of computer system 1100 or may be separate and accessed through other interface systems. Network interface 1185 may provide a direct connection to a remote server via a direct network link to the Internet via a POP (point of presence). Network interface 1185 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., document scanners, digital cameras, and so on). Conversely, all of the devices shown in FIG. 11 need not be present to practice the present systems and methods. The devices and subsystems can be interconnected in different ways from that shown in FIG. 11. The operation of a computer system such as that shown in FIG. 11 is readily known in the art and is not discussed in detail in this application. Code to implement the present disclosure can be stored in a non-transitory computer-readable medium such as one or more of system memory 1115 or fixed disk 1170. The operating system provided on computer system 1100 may be iOS®, MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for displaying a three-dimensional (3D) model from a photogrammetric scan, the method comprising:
obtaining an image of an object and an image of a scan marker at a first location;
determining a relationship between the image of the object and the image of the scan marker at the first location;
determining a geometric property of the object based at least in part on the relationship between the image of the object and the image of the scan marker;
generating a 3D model of the object based at least in part on the determined geometric property of the object; and
displaying the 3D model of the object in a virtual reality environment of a second location based at least in part on a scan marker at the second location.

2. The method of claim 1, further comprising:
capturing the image of the object and the image of the scan marker at the first location with an image-capturing device.

3. The method of claim 2, further comprising:
tracking a position of the image-capturing device while capturing the image of the object and the image of the scan marker at the first location.

4. The method of claim 1, further comprising:
identifying the scan marker at the first location; and
identifying the scan marker at the second location.

5. The method of claim 1, further comprising:
determining an orientation of the scan marker at the first location; and
determining an orientation of the object based at least in part on the determined orientation of the scan marker at the first location.

6. The method of claim 1, further comprising:
determining an orientation of the scan marker at the second location; and
determining an orientation of the 3D model of the object based at least in part on the determined orientation of the scan marker at the second location.

7. The method of claim 1, further comprising:
determining a size of the scan marker at the first location; and
determining a size of the object relative to the determined size of the scan marker at the first location.

8. The method of claim 1, further comprising:
determining a size of the scan marker at the second location; and
determining a size of the 3D model of the object relative to the determined size of the scan marker at the second location.

9. The method of claim 1, further comprising:
displaying the scan marker at the first location on a display device, wherein the display device is positioned adjacent to the object.

10. The method of claim 1, further comprising:
displaying the 3D model of the object over a real-time image of the second location on a display device; and
adjusting a geometric property of the 3D model of the object in relation to an adjustment of a position of the display device.

11. The method of claim 1, further comprising:
encoding data on the scan marker at the first location; and
encoding data on the scan marker at the second location, wherein the scan markers comprise a quick response (QR) code.

12. A computing device configured to display a three-dimensional (3D) model from a photogrammetric scan, comprising:
a processor;
memory in electronic communication with the processor;
instructions stored in the memory, the instructions being executable by the processor to:
obtain an image of an object and an image of a scan marker at a first location;
determine a relationship between the image of the object and the image of the scan marker at the first location;
determine a geometric property of the object based at least in part on the relationship between the image of the object and the image of the scan marker;
generate a 3D model of the object based at least in part on the determined geometric property of the object; and
display the 3D model of the object in virtual reality environment of a second location based at least in part on a scan marker at the second location.

13. The computing device of claim 12, wherein the instructions are further executable by the processor to:
identify the scan marker at the first location; and
identify the scan marker at the second location.

14. The computing device of claim 12, wherein the instructions are further executable by the processor to:
determine an orientation of the scan marker at the first location; and
determine an orientation of the object based on the determined orientation of the scan marker at the first location.

15. The computing device of claim 12, wherein the instructions are further executable by the processor to:
determine an orientation of the scan marker at the second location; and
determine an orientation of the 3D model of the object based at least in part on the determined orientation of the scan marker at the second location.

16. The computing device of claim 12, wherein the instructions are further executable by the processor to:
determine a size of the scan marker at the first location; and
determine a size of the object relative to the determined size of the scan marker at the first location.

17. The computing device of claim 12, wherein the instructions are further executable by the processor to:
determine a size of the scan marker at the second location; and
determine a size of the 3D model of the object relative to the determined size of the scan marker at the second location.

18. The computing device of claim 12, wherein the instructions are further executable by the processor to:
display the scan marker on a display device at the first location, wherein the display device at the first location is positioned adjacent to the object;
display the scan marker on a display device at the second location;
display the 3D model of the object over a real-time image of the second location on a display device; and
adjust a geometric property of the 3D model of the object in relation to an adjustment of a position of the display device.

19. A computer-program product for displaying a three-dimensional (3D) model from a photogrammetric scan, the computer-program product comprising a non-transitory computer-readable medium storing instructions thereon, the instructions being executable by a processor to:
obtain an image of an object and an image of a scan marker at a first location;
determine a relationship between the image of the object and the image of the scan marker at the first location;
determine a geometric property of the object based at least in part on the relationship between the image of the object and the image of the scan marker;
generate a 3D model of the object based at least in part on the determined geometric property of the object; and
display the 3D model of the object in a virtual reality environment of a second location based at least in part on a scan marker at the second location.

20. The computer-program product of claim 19, wherein the instructions are further executable by the processor to:
determine a size and position of the scan marker at the second location;
determine a size and position of the 3D model of the object based at least in part on the determined size and position of the scan marker at the second location;
display the scaled 3D model of the object over a real-time image of the second location on a display device; and
adjust a geometric property of the 3D model of the object in relation to an adjustment of a position of the display device.
